(19) United States
(12) Patent Application Publication
(10) Pub. No.: US 2026/0066188 A1
(43) Pub. Date: Mar. 5, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Dong Chan Seo, Suwon-si (KR); Choongseop Jeon, Suwon-si (KR); Yura Shin, Suwon-si (KR); Seung Yong Lee, Suwon-si (KR)

(73) Assignee: SAMSUNG ELECTRO-MECHANICS CO., LTD., Suwon-si (KR)

(21) Appl. No.: 19/065,670

(22) Filed: Feb. 27, 2025

(30) Foreign Application Priority Data
Sep. 3, 2024 (KR) 10-2024-0119144

(51) Int. Cl. H01G 4/12; H01G 4/30

(52) U.S. Cl. CPC H01G 4/1227; H01G 4/30

(57) ABSTRACT

A multilayer ceramic capacitor including a capacitor body including a dielectric layer and an internal electrode layer, and an external electrode disposed on an outer surface of the capacitor body, wherein the dielectric layer includes a barium titanate-based main component and a subcomponent including cerium (Ce) and dysprosium (Dy), and a Ce/Dy molar ratio is about 1 to about 10.

### CROSS-REFERENCE TO RELATED APPLICATION

This application claims priority to and the benefit of Korean Patent Application No. 10-2024-0119144 filed in the Korean Intellectual Property Office on Sep. 3, 2024, the entire contents of which are incorporated herein by reference.

### BACKGROUND

### (a) Technical Field

The present disclosure relates to a multilayer ceramic capacitor and a method of manufacturing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Currently, as MLCCs become more compact and highly integrated, a ratio of an active region that determines the capacitance characteristics compared to a cover region or margin region is increasing, and accordingly, the implementation of a uniform microstructure in the active region is becoming more important.

### SUMMARY

An embodiment provides a multilayer ceramic capacitor having low distribution in capacitance characteristics.

Another embodiment provides a method of manufacturing a multilayer ceramic capacitor.

An embodiment provides a capacitor body including a dielectric layer and an internal electrode layer, and an external electrode disposed on an outer surface of the capacitor body, wherein the dielectric layer includes a plurality of dielectric grains, the dielectric layer includes a barium titanate-based main component and a subcomponent including cerium (Ce) and dysprosium (Dy), and a Ce/Dy molar ratio is about 1 to about 10.

The dielectric layer may include a plurality of dielectric grains.

The dielectric layer includes a first plurality of dielectric layers and a second plurality of dielectric layers, the internal electrode layer includes a plurality of internal electrode layers, the capacitor body includes an active region that includes the first plurality of the dielectric layer and the plurality of the internal electrode layers alternately arranged, and a cover region that includes the second plurality of the dielectric layers disposed on surfaces of the active region opposing each other in a thickness direction, wherein the active region includes an active center defined as a region from an exact center of the active region to a region where two dielectric layers, among the first plurality of dielectric layers, along the thickness direction, and adjacent to the center of the active region, are visible under a microscope, and an active end defined as a region from a boundary between the active region and the cover region to a region where four dielectric layers among the first plurality of dielectric layers are visible under a microscope, and when an average size of the plurality of dielectric grains at the active center is D1 and the average size of the plurality of dielectric grains at the active end is D2, a dielectric grain size deviation rate obtained from Equation 1 is greater than or equal to about 0% and less than about 10%.

$$Dielectric grain size deviation rate ( \% ) = ( \vert D 1 - D 2 \vert / D 1 ) \times 100 \qquad [ Equation 1 ]$$

wherein a size of the plurality of dielectric grains is an average value of a major axis length and a minor axis length of the plurality of dielectric grains.

When the dielectric grain size deviation rate is greater than 0% and less than about 10%, D1 may have a value greater than D2.

D1 may be about 210 nm to about 230 nm.

D2 may be about 200 nm to about 220 nm.

Cerium (Ce) may be included in an amount of about 1 part by mole to about 2 parts by mole based on 100 parts by mole of the barium titanate-based main component.

Dysprosium (Dy) may be included in an amount of about 0.2 parts by mole to about 1 part by mole based on 100 parts by mole of the barium titanate-based main component.

The capacitance variation coefficient ratio, as calculated by Equation 2, of the multilayer ceramic capacitor may be greater than 0% and less than about 3%.

$$[ Equation 2 ]$$

$$Capacitance variation coefficient ratio ( Cp CV ) ( \% ) = \{ capacitance standard deviation ( {σ}_{1} ) / capacitance mean \} \times 100$$

wherein, in Equation 2, capacitance standard deviation (σ₁) is a square root of an average of squares of capacitance deviations.

A dielectric loss variation coefficient ratio, as calculated by Equation 3, of the multilayer ceramic capacitor may be greater than about 0% and less than about 6%.

$$[ Equation 3 ]$$

$$Dielectric loss variation coefficient ratio ( DF CV ) ( \% ) = \{ Dielectric loss standard deviation ( {σ}_{2} ) / Dielectric loss mean \} \times 100$$

wherein, in Equation 3, dielectric loss standard deviation (σ₂) is a square root of an average of squares of dielectric loss deviations.

Another embodiment provides a method of manufacturing a multilayer ceramic capacitor which includes: mixing barium titanate-based main component powder and subcomponent powder to prepare a dielectric slurry; manufacturing a plurality of dielectric green sheets from the dielectric slurry and forming a conductive paste layer on a surface of each dielectric green sheet among the plurality of dielectric green sheets; manufacturing a dielectric green sheet stack by stacking the plurality of dielectric green sheets on which the conductive paste layer is formed; manufacturing a capacitor body including a dielectric layer and an internal electrode layer by firing the dielectric green sheet stack; and forming an external electrode on one surface of the capacitor body, wherein the dielectric layer includes a barium titanate-based main component and a subcomponent including cerium (Ce) and dysprosium (Dy), the subcomponent powder includes a Ce-containing compound and a Dy-containing compound, and the Ce-containing compound and the Dy-containing compound are included in an amount such that a Ce/Dy molar ratio is about 1 to about 10.

The Ce-containing compound may be included in an amount such that Ce may be about 1 part by mole to about 2 parts by mole based on 100 parts by mole of the barium titanate-based main component.

The Dy-containing compound may be included in an amount such that Dy may be about 0.2 parts by mole to about 1 part by mole based on 100 parts by mole of the barium titanate-based main component.

The Ce-containing compound and the Dy-containing compound may each include an oxide, a nitride, or a salt compound, or the Ce-containing compound and the Dy-containing compound may include a sol form dispersed in an organic solvent.

The Ce-containing compound may include CeO₂, and the Dy-containing compound may include Dy₂O₃.

An embodiment provides a capacitor body including a dielectric layer and an internal electrode layer, the dielectric layer including cerium (Ce) and dysprosium (Dy), wherein a Ce/Dy molar ratio is 1 to 10, and an external electrode disposed on an outer surface of the capacitor body.

The dielectric layer may include a plurality of dielectric grains.

The dielectric layer includes a first plurality of dielectric layers and a second plurality of dielectric layers, the internal electrode layer includes a plurality of internal electrode layers, the capacitor body includes an active region that includes the first plurality of dielectric layers and the plurality of the internal electrode layers alternately arranged, and a cover region that includes the second plurality of dielectric layers disposed on surfaces of the active region opposing each other in a thickness direction, wherein the active region includes an active center defined as a region from an exact center of the active region to a region where two dielectric layers, among the first plurality of dielectric layers, along the thickness direction, and adjacent to the center of the active region, are visible under a microscope, and an active end defined as a region from a boundary between the active region and the cover region to a region where four dielectric layers among the first plurality of dielectric layers are visible under a microscope, and when an average size of the plurality of dielectric grains at the active center is D1 and the average size of the plurality of dielectric grains at the active end is D2, a dielectric grain size deviation rate obtained from Equation 1 is greater than or equal to about 0% and less than about 10%.

Dielectric grain size deviation rate (%)=(|D1−D2|/D1)×100 [Equation 1]

wherein a size of the plurality of dielectric grains is an average value of a major axis length and a minor axis length of the plurality of dielectric grains.

When the dielectric grain size deviation rate is greater than 0% and less than about 10%, D1 may have a value greater than D2.

D1 may be about 210 nm to about 230 nm.

D2 may be about 200 nm to about 220 nm.

A multilayer ceramic capacitor according to an embodiment can reduce distribution of capacitance characteristics by having a uniform microstructure with a reduced size deviation of dielectric grains according to location in an active region.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5A is a schematic view showing the cross-sectional microstructure of one dielectric layer included in region A of FIG. 3.

FIG. 5B is a schematic view showing the cross-sectional microstructure of one dielectric layer included in region B of FIG. 3.

FIGS. 6A to 6C are each an EPMA (electron probe microanalyzer) analysis image of the active center of the active region according to Example 3.

FIGS. 7A and 7C each illustrates the location of the active region analyzed in Example 3.

FIGS. 7B and 7D are each a SEM (scanning electron microscope) analysis image of the active region illustrated in FIGS. 7A and 7C, respectively, for Example 3.

FIGS. 8A and 8C each illustrates the location of the active region analyzed in Comparative Example 6.

FIGS. 8B and 8D are each a SEM (scanning electron microscope) analysis image of the active region illustrated in FIGS. 8A and 8C, respectively, for Comparative Example 6.

FIG. 9 is a graph showing the distribution of the capacitance (Cp) of the multilayer ceramic capacitors according to Examples 1 to 3 and Comparative Examples 1 to 7.

FIG. 10 is a graph showing the distribution of the dielectric loss (dissipation factor, DF) of the multilayer ceramic capacitors according to Examples 1 to 3 and Comparative Examples 1 to 7.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

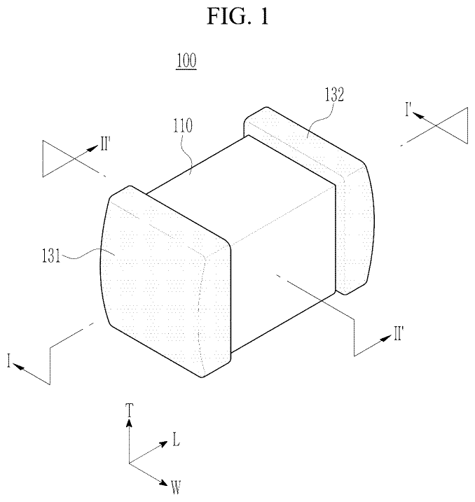

Hereinafter, a multilayer ceramic capacitor according to an embodiment will be described with reference to FIGS. 1 to 4.

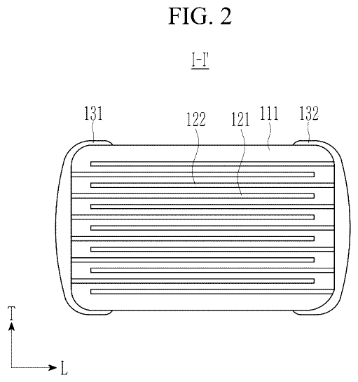

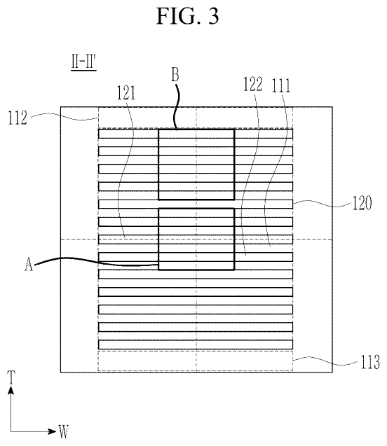

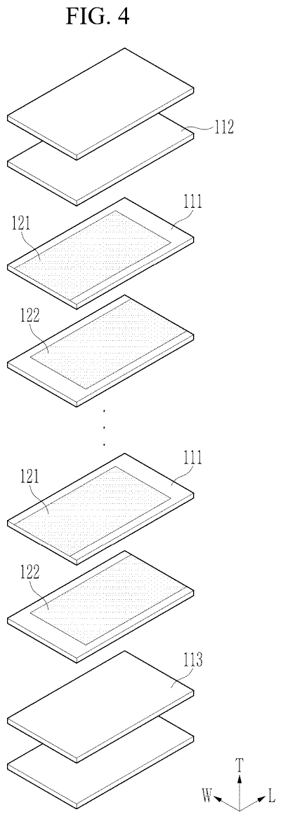

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outside the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region 120 and cover regions 112 and 113.

The active region 120 is a region where the dielectric layer 111 and the internal electrode layers 121 and 122 are alternately disposed, which contributes to forming capacitance of the multilayer ceramic capacitor 100. Specifically, the active region 120 may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region 120, respectively.

Additionally, the capacitor body 110 may further include a side margin region.

The side margin region is a width-direction margin portion and may be disposed on opposite side ends of the active region 120 in the width direction (W-axis direction), that is, on the fifth surface and the sixth surface, respectively. The side margin region may be formed according as, when the conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin region serve to prevent damage to the first internal electrode layer 121 and the second internal electrode layer 122 due to physical or chemical stress.

The dielectric layer 111 within the active region 120 may include a plurality of dielectric grains.

The dielectric layer 111 may include a barium titanate-based main component and subcomponent.

The barium titanate-based main component is a dielectric base material, has a high dielectric constant, and contributes to forming the dielectric constant of a multilayer ceramic capacitor 100.

The barium titanate-based main component is a compound including barium (Ba) and titanium (Ti), and may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The subcomponent may include cerium (Ce) and dysprosium (Dy).

The base material particles within the active region undergo densification and grain growth during the firing process, and the dielectric constant and reliability are determined by the size and degree of densification of the grain-grown dielectric crystals. In general, the degree of grain growth varies depending on firing conditions and additive composition. However, even if the firing conditions or additive compositions are the same, the degree of grain growth may vary depending on the location in the active region, which is the widest region in the multilayer ceramic capacitor, and as the size deviation of the dielectric grains depending on the location in the active region increases, this may cause an increase in the deviation in the capacitance.

According to an embodiment, cerium (Ce) and dysprosium (Dy) may be included in the dielectric layer 111 in a predetermined range of ratios. Specifically, the molar ratio of Ce to Dy, i.e., the Ce/Dy molar ratio, may be about 1 to about 10, and for example, about 2 to about 9, about 3 to about 8, about 4 to about 7, or about 5 to about 6. When the Ce/Dy molar ratio is within the above range, the size deviation of dielectric grains by location within the active region 120 may be reduced. That is, since the microstructure of the dielectric grains is uniform throughout the active region 120, a multilayer ceramic capacitor with less deviation in capacitance characteristics, i.e., reduced distribution in capacitance characteristics, can be secured.

The Ce/Dy molar ratio within the dielectric layer 111 may be confirmed by electron probe microanalysis (EPMA). Other methods and/or tools appreciated by one of ordinary skill in the art, even if not described in the present disclosure, may also be used.

In more detail, after the multilayer ceramic capacitor 100 was placed into the epoxy mixture liquid and then cured, the W-axis and the T-axis directional surface (WT surface) of the capacitor body 110 was polished to ½ depth in the L-axis direction, and then by fixing and maintaining it in the vacuum atmosphere chamber, a cross-sectional sample may be obtained such that the active region where the dielectric layer 111 and the internal electrode layers 121 and 122 intersect may be observed. By performing EPMA analysis on the obtained cross-sectional sample under conditions of an acceleration voltage of 15 kV and a residence time of 40 ms, the presence of elements existing in the dielectric layer 111 can be confirmed, and the content of each element can be confirmed from the intensity obtained during EPMA analysis.

The microstructure of the dielectric layer 111 at each location within the active region 120 can be explained through FIGS. 5A and 5B.

FIG. 5A is a schematic view showing the cross-sectional microstructure of one dielectric layer included in region A of FIG. 3 and FIG. 5B is a schematic view showing the cross-sectional microstructure of one dielectric layer included in region B of FIG. 3.

Referring to FIG. 3, an active region 120 according to an embodiment may include an active center A corresponding to the center, and an active end B corresponding to an end adjacent to cover regions 112 and 113. Specifically, the active center A can be defined as a region where two dielectric layers are visible from the center of the active region 120 to the upper and lower portions in the thickness direction (T axis). Additionally, the active end B can be defined as a region from the boundary between the active region 120 and the cover regions 112 and 113 to a region where four dielectric layers are visible in the direction of the active region 120. At this time, only one active end B is shown in FIG. 3, but this is only for convenience, and any end adjacent to the cover regions 112 and 113 in the active region 120 can correspond to the active end B.

Additionally, referring to FIGS. 5A and 5B, the dielectric layer 111 within the active region 120 may include a plurality of dielectric grains 10.

According to an embodiment, when the average size of a plurality of dielectric grains at the active center A is D1 and the average size of a plurality of dielectric grains at the active end B is D2, the dielectric grain size deviation rate obtained from Equation 1 may be greater than or equal to about 0% and less than about 10%, for example about 0.01% to about 9.9% or about 0.01% to about 9.8%.

$$Dielectric grain size deviation rate ( \% ) = ( \vert D 1 - D 2 \vert / D 1 ) \times 100 \qquad [ Equation 1 ]$$

When the dielectric grain size deviation rate is within the above range, the microstructure of the dielectric grains is uniform throughout the active region, so that a multilayer ceramic capacitor with reduced distribution of capacitance characteristics can be secured.

The average sizes D1 and D2 of the dielectric grains can be measured by scanning electron microscope (SEM) analysis of the active region. Other methods and/or tools appreciated by one of ordinary skill in the art, even if not described in the present disclosure, may also be used.

Specifically, in the cross-sectional sample obtained by the above-described method, the active center A defined as a region from the exact center of the active region 120 to the upper and lower regions where two dielectric layers are visible in the thickness direction (T axis), and the active end B defined as a region from the boundary between the active region 120 and the cover regions 112 and 113 to the active region 120 where four dielectric layers are visible can be measured using SEM. For example, SEM can be measured under conditions of an acceleration voltage of 2.0 kV in a region of about 5 μm×5 μm where at least four dielectric layers (111) are visible at each of the active center A and the active edge B. Through the SEM image of the measured cross-sectional sample, the average size D1 of multiple dielectric grains present in the active center A and the average size D2 of multiple dielectric grains present in the active end B can be obtained, respectively.

The size of a dielectric grain is obtained as the average value of the major axis length and minor axis length of one dielectric grain, and the average sizes D1 and D2 of a plurality of dielectric grains can be calculated as the average values of the sizes of a plurality of dielectric grains present at the active center A and active end B, respectively. For example, D1 and D2 may be obtained as the size averages of 100 to 500 dielectric grains, for example, the size averages of 150 to 400, 200 to 300 dielectric grains.

In FIGS. 5A and 5B, the sizes of the dielectric grains 10 at the active center A and the active end B are shown to be different from each other, but an embodiment is not limited thereto. That is, FIGS. 5A and 5B should be viewed only as presented to help understand the size deviation of dielectric grains by location in the active region.

When the dielectric grain size deviation rate is greater than 0%, D1 may have a value greater than D2, and in this case, the capacitance characteristics of the multilayer ceramic capacitor are improved.

The average size D1 of the plurality of dielectric grains in the active center A may be about 210 nm to about 230 nm, for example, about 215 nm to about 230 nm, or about 220 nm to about 230 nm. When D1 is within the above range, the size deviation of dielectric grains by location within the active region 120 may be reduced, and accordingly, the distribution of the capacitance characteristics of the multilayer ceramic capacitor may be reduced.

The average size D2 of the plurality of dielectric grains at the active end B may be about 200 nm to about 220 nm, for example about 200 nm to about 215 nm, or about 200 nm to about 210 nm. When D2 is within the above range, the size deviation of dielectric grains by location within the active region 120 may be reduced, and accordingly, the distribution of the capacitance characteristics of the multilayer ceramic capacitor may be reduced.

In the dielectric layer 111, the cerium (Ce) may be included in an amount of about 1 part by mole to about 2 parts by mole, for example about 1.1 parts by mole to about 1.9 parts by mole, about 1.2 parts by mole to about 1.8 parts by mole, or about 1.3 parts by mole to about 1.7 parts by mole based on 100 parts by mole of the barium titanate-based main component. When cerium (Ce) is included in the above content range, the size deviation of dielectric grains by location within the active region 120 is reduced, so that the microstructure of the dielectric grains throughout the active region is uniform, thereby securing a multilayer ceramic capacitor with reduced distribution of capacitance characteristics.

In the dielectric layer 111, the dysprosium (Dy) may be included in an amount of 0.2 parts by mole to 1 part by mole, for example 0.3 parts by mole to 0.9 parts by mole, 0.4 parts by mole to 0.8 parts by mole, or 0.5 parts by mole to 0.7 parts by mole based on 100 parts by mole of the barium titanate-based main component. When dysprosium (Dy) is included in the above content range, the size deviation of dielectric grains by location within the active region 120 is reduced, so that the microstructure of the dielectric grains throughout the active region is uniform, thereby securing a multilayer ceramic capacitor with reduced distribution of capacitance characteristics.

An average thickness (average length in the T-axis direction) of the dielectric layer 111 may be about 2.0 μm to about 8.0 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 may be measured by placing the multilayer ceramic capacitor 100 in an epoxy mixing solution, curing it, polishing it, and then ion milling it, and then analyzing it using a scanning electron microscope (SEM). A scanning electron microscope can be used, for example, using a Verios G4 product from Thermofisher Scientific, with measurement conditions of 10 kV and 0.2 nA, an analysis magnification of 100 times, and may be measured for at least 1 layer, 3 layers, 5 layers, or 10 layers or more of dielectric layers 111. This may be an arithmetic mean value obtained by taking the central point of the length direction (L-axis direction) or width direction (W-axis direction) of the dielectric layer 111 as a reference point in a scanning electron microscope (SEM) image of a cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted.

The internal electrode layers 121 and 122, i.e., the first internal electrode layer 121 and the second internal electrode layer 122, are electrodes having different polarities and are alternately arranged to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The first internal electrode layer 121 and the second internal electrode layer 122 include a conductive metal, and may include, for example, a metal such as Ni, Cu, Ag, Pd, Au, or an alloy thereof, for example, an Ag—Pd alloy.

Additionally, the first internal electrode layer 121 and the second internal electrode layer 122 may include dielectric particles having the same composition as the ceramic material included in the dielectric layer 111.

The first internal electrode layer 121 and the second internal electrode layer 122 may be formed using a conductive paste including a conductive metal. The printing method for the conductive paste may be either screen printing or gravure printing.

Each average thickness of the first internal electrode layer 121 and the second internal electrode layer 122 may be about 0.1 μm to about 2 μm. The average thickness of the first internal electrode layer 121 and the second internal electrode layer 122 may be measured by scanning electron microscope (SEM) analysis. Here, the scanning electron microscope (SEM) analysis is the same as the method used to measure the average thickness of the dielectric layer 111 described above, so its description is omitted.

The capacitor body 110 may be formed by firing a stacking structure in which the plurality of dielectric layers 111 and internal electrode layers 121 and 122 are stacked.

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the first internal electrode layer 121 and the second internal electrode layer 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The first external electrode 131 and the second external electrode 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

A multilayer ceramic capacitor according to an embodiment can reduce distribution of capacitance characteristics. Specifically, the capacitance variation coefficient ratio of the multilayer ceramic capacitor obtained by Equation 2 may be greater than about 0% and less than about 3%, for example, about 0.01% to about 2.9%, or about 0.01% to about 2.8%.

$$[ Equation 2 ]$$

$$Capacitance variation coefficient ratio ( Cp CV ) ( \% ) = \{ capacitance standard deviation ( {σ}_{1} ) / capacitance mean \} \times 100$$

In Equation 2, the capacitance standard deviation (σ₁) means a square root of the squares of the capacitance deviations. The capacitance standard deviation (σ₁) is calculated by dividing a sum of the squares of the capacitance deviations by the number of measurements and taking the square root of the quotient, i.e., an average of the squares of the capacitance deviations as in Equation 2-1.

$${σ}_{1} = \sqrt{\frac{1}{n} {\sum }_{i = 1}^{n} {( {x}_{i} - \overline{x} )}^{2}} \qquad [ Equation 2 - 1 ]$$

For example, for about 50 multilayer ceramic capacitors, the capacitance of each can be measured (e.g., with a capacitance meter) under 120 Hz and 0.5 V conditions, and the average value of these can be calculated to obtain the capacitance mean. Other methods and/or tools appreciated by one of ordinary skill in the art, even if not described in the present disclosure, may also be used.

In addition, the dielectric loss variation coefficient ratio of the multilayer ceramic capacitor obtained by Equation 3 may be greater than 0% and less than about 6%, for example about 0.01% to about 5.8%, or about 0.01% to about 5.6%.

$$[ Equation 3 ]$$

$$Dielectric loss variation coefficient ratio ( DF CV ) ( \% ) = \{ dielectric loss standard deviation ( {σ}_{2} ) / dielectric loss mean \} \times 100$$

In Equation 3, the dielectric loss standard deviation (σ₂) is obtained by dividing a sum of the squares of the dielectric loss deviations by the number of measurements, and then taking the square root of the quotient, i.e., a square root of the average of the squares of the dielectric loss deviations as in Equation 3-1.

$${σ}_{2} = \sqrt{\frac{1}{n} {\sum }_{i = 1}^{n} {( {x}_{i} - \overline{x} )}^{2}} \qquad [ Equation 3 - 1 ]$$

For example, for about 50 multilayer ceramic capacitors, the dielectric loss of each can be measured (e.g., with a capacitance meter) under 120 Hz and 0.5 V conditions, and the average value of these can be calculated to obtain the dielectric loss mean. Other methods and/or tools appreciated by one of ordinary skill in the art, even if not described in the present disclosure, may also be used.

Hereinafter, a method of manufacturing the multilayer ceramic capacitor 100 according to an embodiment will be described.

A multilayer ceramic capacitor 100 according to an embodiment may be manufactured by mixing barium titanate-based main component powder and subcomponent powder to prepare a dielectric slurry; manufacturing a dielectric green sheet using the dielectric slurry and forming a conductive paste layer on the surface of the dielectric green sheet; manufacturing a dielectric green sheet stack by stacking the dielectric green sheet on which the conductive paste layer is formed; manufacturing a capacitor body including a dielectric layer and an internal electrode layer by firing the dielectric green sheet stack; and forming an external electrode on one surface of the capacitor body.

The barium titanate-based main component powder is a compound including barium (Ba) and titanium (Ti), and may include, for example, BaTiO₃, Ba(Ti, Zr)O₃, Ba(Ti, Sn)O₃, (Ba, Ca)TiO₃, (Ba, Ca)(Ti, Ca)O₃, (Ba, Ca)(Ti, Zr)O₃, (Ba, Ca)(Ti, Sn)O₃, (Ba, Sr)TiO₃, (Ba, Sr)(Ti, Zr)O₃, (Ba, Sr)(Ti, Sn)O₃, or a combination thereof.

The subcomponent powder may include a Ce-containing compound and a Dy-containing compound.

The Ce-containing compound and the Dy-containing compound may be included in an amount such that the molar ratio of Ce to Dy, i.e., the Ce/Dy molar ratio, may be about 1 to about 10, and may be included in an amount such that the Ce/Dy molar ratio may be about 2 to about 9, about 3 to about 8, about 4 to about 7, or about 5 to about 6. When the Ce-containing compound and the Dy-containing compound are included in the above molar ratio range, the size deviation of the dielectric grains according to location within the active region 120 is reduced, so that a multilayer ceramic capacitor with reduced distribution of capacitance characteristics can be secured.

The Ce-containing compound may be included such that Ce may be included in an amount of about 1 part by mole to about 2 parts by mole, for example about 1.1 parts by mole to about 1.9 parts by mole, about 1.2 parts by mole to about 1.8 parts by mole, or about 1.3 parts by mole to about 1.7 parts by mole based on 100 parts by mole of the barium titanate-based main component. When the Ce-containing compound is included in the above content range, the distribution of the capacitance characteristics of the multilayer ceramic capacitor may be reduced as the microstructure of the dielectric grains is uniform throughout the active region.

The Dy-containing compound may be included in an amount of may be included such that Dy may be included in an amount of about 0.2 parts by mole to about 1 part by mole, for example about 0.3 parts by mole to about 0.9 parts by mole, about 0.4 parts by mole to about 0.8 parts by mole, or about 0.5 parts by mole to about 0.7 parts by mole based on 100 parts by mole of the barium titanate-based main component. When the Dy-containing compound is included in the above content range, the distribution of the capacitance characteristics of the multilayer ceramic capacitor may be reduced as the microstructure of the dielectric grains is uniform throughout the active region.

The Ce-containing compound and the Dy-containing compound may be an oxide, a nitride or a salt compound, respectively, or may be used in the form of a sol dispersed in an organic solvent.

The dielectric slurry may be prepared by additionally mixing additives such as a dispersant, a binder, a plasticizer, a lubricant, an antistatic agent, and a solvent.

The dispersant may include for example a phosphoric acid ester-based dispersant, a polycarboxylic acid-based dispersant, or a combination thereof. The dispersant may be mixed in an amount of about 0.1 part by weight to about 5 parts by weight, for example, about 0.3 parts by weight to about 3 parts by weight based on 100 parts by weight of the barium titanate-based main component powder. When the dispersant is mixed within the above content range, the dielectric slurry shows excellent dispersibility, and the amount of impurities included in the manufactured dielectric layer may be reduced.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based main component powder. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based main component powder. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based main component powder. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form a conductive paste layer that becomes an internal electrode layer after firing, a conductive paste may be prepared by mixing a conductive powder made of a conductive metal or an alloy thereof, a binder, and a solvent. Additionally, a barium titanate powder may be mixed in as a co-material if necessary. The co-material may act to suppress sintering of the conductive powder during the firing process. In the step of manufacturing the dielectric green sheet, a dielectric slurry may be prepared by mixing a barium titanate-based compound as a main component powder and optionally a subcomponent powder.

The conductive powder may include nickel (Ni) or a nickel (Ni) alloy.

Next, a dielectric green sheet stack is manufactured by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (calcining) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 3 and Comparative Examples 1 to 7

BaTiO₃ main component powder was mixed with CeO₂ and Dy₂O₃ as subcomponent powder to have Ce and Dy content shown in Table 1 to prepare a dielectric slurry. In Table 1, each of the Ce and Dy contents was expressed by parts by mole based on 100 parts by mole of BaTiO₃.

In the preparation of the dielectric slurry, zirconia balls (ZrO₂ balls) was used as a dispersion medium, and ethanol/toluene, a wetting dispersant, and a polyvinyl butyral (PVB) resin as a binder were added thereto and then, mechanically milled.

The prepared dielectric slurry was used to manufacture a dielectric green sheet by using a head discharge type on-roll forming coater.

On the surface of the dielectric green sheet, a conductive paste layer including nickel (Ni) was printed, and the dielectric green sheets on which the conductive paste layers were formed were stacked and pressed to manufacture a dielectric green sheet stack.

The dielectric green sheet stack was calcinated at 400° C. or less under a nitrogen atmosphere and fired at 1300° C. or less at a hydrogen (H₂) concentration of 1.0% or less.

Subsequently, the dielectric green sheet stack was used to manufacture a multilayer ceramic capacitor through processes of an external electrode, plating, or the like.

TABLE 1

| | Ce content | Dy content | |
|---|---|---|---|
| | (parts by | (parts by | Ce/Dy |
| | mole) | mole) | molar ratio |
| Example 1 | 1 | 1 | 1 |
| Example 2 | 1 | 0.2 | 5 |
| Example 3 | 2 | 0.2 | 10 |
| Comparative Example 1 | 1 | 2 | 0.5 |
| Comparative Example 2 | 0.9 | 1.5 | 0.6 |
| Comparative Example 3 | 0.8 | 1 | 0.8 |
| Comparative Example 4 | 0.2 | 2 | 0.1 |
| Comparative Example 5 | 0.3 | 1.5 | 0.2 |
| Comparative Example 6 | 0.6 | 1.5 | 0.4 |
| Comparative Example 7 | 1.8 | 0.12 | 15 |

### Evaluation 1: EPMA Analysis

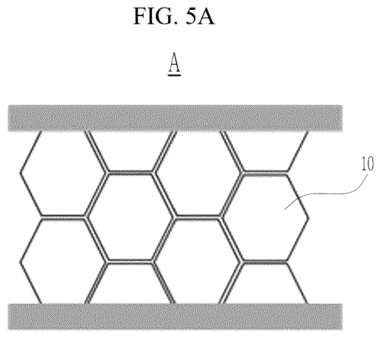

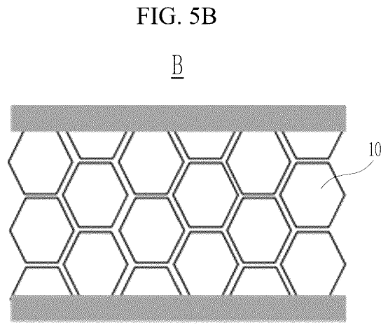

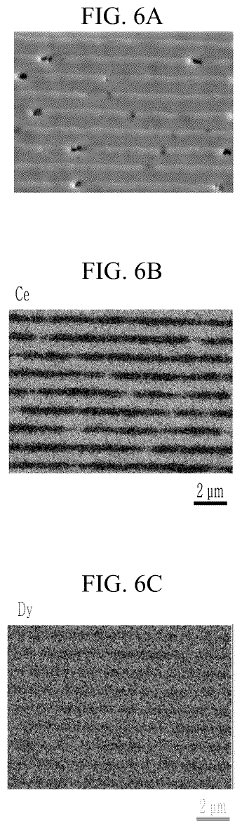

The multilayer ceramic capacitors according to Examples 1 to 3 and Comparative Examples 1 to 7 were subjected to an electron probe microanalysis (EPMA), and the results are shown in FIGS. 6A to 6C.

Specifically, the multilayer ceramic capacitors manufactured in Examples 1 to 3 and Comparative Examples 1 to 7 were placed into an epoxy mixture liquid and cured, and the W-axis and T-axis direction surface (WT surface) of each capacitor body was polished to a depth of ½ in the L-axis direction and then, fixed and maintained in a vacuum atmosphere chamber to obtain cross-sectional samples to observe an active region where a dielectric layer and an internal electrode layer intersect. The obtained cross-sectional samples were subjected to an EPMA analysis at an acceleration voltage of 15 kV for a dwell time of 40 ms to check elements present in the dielectric layer and their contents.

FIGS. 6A to 6C are each an EPMA (electron probe microanalyzer) analysis image of the active region according to Example 3.

Referring to FIGS. 6A to 6C, it was confirmed that Ce and Dy were detected in the dielectric layer in the active region according to an embodiment, wherein the Ce and Dy were included in a Ce/Dy molar ratio shown in Table 1.

### Evaluation 2: SEM Analysis

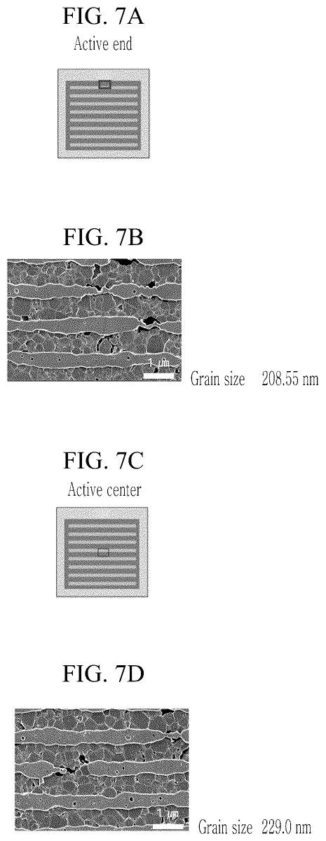

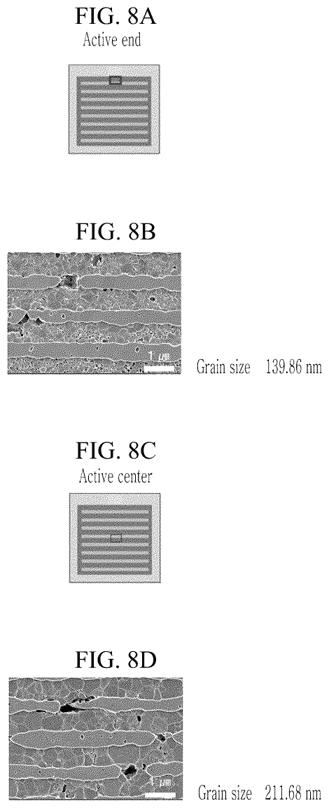

The multilayer ceramic capacitors according to Examples 1 to 3 and Comparative Examples 1 to 7 were subjected to an SEM (scanning electron microscope) analysis, and the results are shown in Table 2 and FIGS. 7 and 8.

Specifically, the active region of the cross-sectional sample of Evaluation 1 was examined with SEM with respect to an active center A, which was defined from an exact center of the active region to upper and lower regions where two dielectric layers were respectively visible in a thickness direction (T-axis) and an active edge B which was defined from a boundary between active region and cover region to a region where four dielectric layers were visible in an active region direction. The SEM was measured at an acceleration voltage of 2.0 kV in the region of about 5 μm×5 μm where four dielectric layers 111 were visible at each of the active center A and the active edge B. The SEM image of the cross-sectional sample was used to obtain an average size D1 of a plurality of dielectric grains at the active center A and an average size D2 of a plurality of dielectric grains at the active edge B, which were used to calculate a size deviation ratio (%) of the dielectric grains.

The size deviation ratio (%) of the dielectric grains was obtained according to Equation 1. Herein, D1 and D2 are respectively an average size of the plurality of dielectric grains present in each of the active center A and the active edge B. Herein, a size of the dielectric grains was obtained as an average of a major axis length of each of the dielectric grains, which was measured by using a Max feret diameter and an average of a minor axis length of each of the dielectric grains, which was measured by using an orthogonal feret diameter.

$$Dielectric grain size deviation rate ( \% ) = ( \vert D 1 - D 2 \vert / D 1 ) \times 100 \qquad [ Equation 1 ]$$

FIGS. 7A and 7C each illustrates the location of the active region analyzed in Example 3, FIGS. 7B and 7D are each a SEM (scanning electron microscope) analysis image of the active region illustrated in FIGS. 7A and 7C, respectively, for Example 3, FIGS. 8A and 8C each illustrates the location of the active region analyzed in Comparative Example 6, and FIGS. 8B and 8D are each a an SEM (scanning electron microscope) analysis image of the active region illustrated in FIGS. 8A and 8C, respectively, for Comparative Example 6.

Referring to Table 2 and FIGS. 7A to 8D, Examples 1 to 3, compared to Comparative Examples 1 to 7, were confirmed that the dielectric grains had a small size deviation ratio of less than 10%. Accordingly, when a Ce/Dy molar ratio within the dielectric layer was within a range of 1 to 10 according to an embodiment, the dielectric grains had a reduced size deviation by a location in the active region, resulting in a uniform microstructure.

### Evaluation 3: Capacitance Characteristics

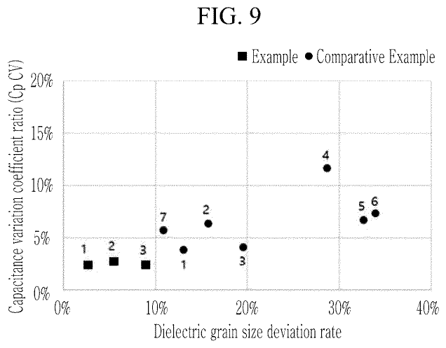

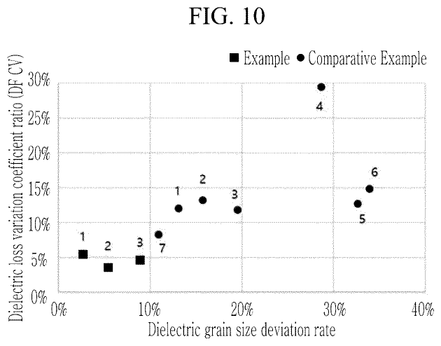

The multilayer ceramic capacitors of Examples 1 to 3 and Comparative Examples 1 to 7 were measured with respect to capacitance characteristics, and the results are shown in Table 2 and FIGS. 9 and 10.

Specifically, each of the multilayer ceramic capacitors according to Examples 1 to 3 and Comparative Examples 1 to 7 was prepared by 50, which were measured with respect to capacitance under conditions of 120 Hz and 0.5 V by a 4268A capacitance meter, and the measurements was averaged to obtain a capacitance mean, which was used to calculate a capacitance variation coefficient ratio.

In Table 2, the capacitance variation coefficient ratio was obtained according to Equation 2. Herein, a capacitance standard deviation (σ₁) is a square root of a mean of squares of capacitance deviations.

$$[ Equation 2 ]$$

$$Capacitance variation coefficient ratio ( Cp CV ) ( \% ) = \{ capacitance standard deviation ( {σ}_{1} ) / capacitance mean \} \times 100$$

In addition, each of the multilayer ceramic capacitors of Examples 1 to 3 and Comparative Examples 1 to 7 was prepared by 50, which were measured with respect to a dielectric loss under the conditions of 120 Hz and 0.5 V by using the 4268A capacitance meter, and the measurements were averaged to obtain a dielectric loss mean, which was used to calculate a dielectric loss variation coefficient ratio.

In Table 2, the dielectric loss variation coefficient ratio was obtained according to Equation 3. Herein, dielectric loss standard deviation (σ₁) is a square root of a mean of squares of dielectric loss deviations.

$$[ Equation 3 ]$$

$$Dielectric loss variation coefficient ratio ( DF CV ) ( \% ) = \{ dielectric loss standard deviation ( {σ}_{2} ) / dielectric loss mean \} \times 100$$

FIG. 9 is a graph showing the capacitance (Cp) distributions of the multilayer ceramic capacitors according to Examples 1 to 3 and Comparative Examples 1 to 7 and FIG. 10 is a graph showing the dielectric loss (dissipation factor (DF)) distributions of the multilayer ceramic capacitors according to Examples 1 to 3 and Comparative Examples 1 to 7.

Referring to Table 2 and FIGS. 9 and 10, Examples 1 to 3, compared to Comparative Examples 1 to 7, exhibited a capacitance variation coefficient ratio of less than 3% and a dielectric loss variation coefficient ratio of less than 6%. Accordingly, when a Ce/Dy molar ratio in a dielectric layer was within a range of 1 to 10 according to an embodiment, dielectric grains had a reduced size deviation by location in the active region, thereby providing a uniform microstructure, which confirmed that the capacitance characteristics distribution was reduced.

TABLE 2

| | | | Capacitance characteristics | |
|---|---|---|---|---|
| | | | Capacitance | Dielectric |
| | | Dielectric | variation | loss variation |
| | Ce/Dy | grain size | coefficient | coefficient |
| | molar | deviation | ratio | ratio |
| | ratio | rate (%) | (Cp CV) (%) | (DF CV) (%) |
| Example 1 | 1 | 2.68 | 2.42 | 5.54 |
| Example 2 | 5 | 5.46 | 2.73 | 3.58 |
| Example 3 | 10 | 8.91 | 2.47 | 4.70 |
| Comparative | 0.5 | 13.06 | 3.91 | 12.06 |
| Example 1 | | | | |
| Comparative | 0.6 | 15.73 | 6.41 | 13.24 |
| Example 2 | | | | |
| Comparative | 0.8 | 19.50 | 4.12 | 11.90 |
| Example 3 | | | | |
| Comparative | 0.1 | 28.66 | 11.68 | 29.43 |
| Example 4 | | | | |
| Comparative | 0.2 | 32.63 | 6.75 | 12.78 |
| Example 5 | | | | |
| Comparative | 0.4 | 33.92 | 7.39 | 14.85 |
| Example 6 | | | | |
| Comparative | 15 | 10.87 | 5.77 | 8.31 |
| Example 7 | | | | |

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outer surface of the capacitor body,
wherein the dielectric layer includes a barium titanate-based main component and a subcomponent including cerium (Ce) and dysprosium (Dy), and
a Ce/Dy molar ratio is 1 to 10.

2. The multilayer ceramic capacitor of claim 1, wherein
the dielectric layer includes a plurality of dielectric grains.

3. The multilayer ceramic capacitor of claim 2, wherein
the dielectric layer includes a first plurality of dielectric layers and a second plurality of dielectric layers,
the internal electrode layer includes a plurality of internal electrode layers,
the capacitor body includes:
an active region that includes the first plurality of dielectric layers and the plurality of the internal electrode layers alternately arranged, and
a cover region that includes the second plurality of dielectric layers disposed on surfaces of the active region opposing each other in a thickness direction,
wherein the active region includes an active center defined as a region from an exact center of the active region to a region where two dielectric layers, among the first plurality of dielectric layers, along the thickness direction, and adjacent to the center of the active region, are visible, and an active end defined as a region from a boundary between the active region and the cover region to a region where four dielectric layers among the first plurality of dielectric layers are visible, and
when an average size of the plurality of dielectric grains at the active center is D1 and the average size of the plurality of dielectric grains at the active end is D2, a dielectric grain size deviation rate obtained from Equation 1 is greater than or equal to 0% and less than 10%:
$$Dielectric grain size deviation rate ( \% ) = ( \vert D 1 - D 2 \vert / D 1 ) \times 100 \qquad [ Equation 1 ]$$
wherein a size of the plurality of dielectric grains is an average value of a major axis length and a minor axis length of the plurality of dielectric grains.

4. The multilayer ceramic capacitor of claim 3, wherein
when the dielectric grain size deviation rate is greater than 0% and less than 10%, D1 has a value greater than D2.

5. The multilayer ceramic capacitor of claim 3, wherein
D1 is 210 nm to 230 nm.

6. The multilayer ceramic capacitor of claim 3, wherein
D2 is 200 nm to 220 nm.

7. The multilayer ceramic capacitor of claim 1, wherein
cerium (Ce) is included in an amount of 1 part by mole to 2 parts by mole based on 100 parts by mole of the barium titanate-based main component.

8. The multilayer ceramic capacitor of claim 1, wherein
dysprosium (Dy) is included in an amount of 0.2 parts by mole to 1 part by mole based on 100 parts by mole of the barium titanate-based main component.

9. The multilayer ceramic capacitor of claim 1, wherein
a capacitance variation coefficient ratio, as calculated by Equation 2, of the multilayer ceramic capacitor is greater than 0% and less than 3%:
$$[ Equation 2 ]$$
$$Capacitance variation coefficient ratio ( Cp CV ) ( \% ) = \{ capacitance standard deviation ( {σ}_{1} ) / capacitance mean \} \times 100$$
wherein, in Equation 2, capacitance standard deviation (σ₁) is a square root of an average of squares of capacitance deviations.

10. The multilayer ceramic capacitor of claim 1, wherein
a dielectric loss variation coefficient ratio, as calculated by Equation 3, of the multilayer ceramic capacitor is greater than 0% and less than 6%:
$$[ Equation 3 ]$$
$$Dielectric loss variation coefficient ratio ( DF CV ) ( \% ) = \{ dielectric loss standard deviation ( {σ}_{2} ) / dielectric loss mean \} \times 100$$
wherein, in Equation 3, dielectric loss standard deviation (σ₂) is a square root of an average of squares of dielectric loss deviations.

11. A method of manufacturing a multilayer ceramic capacitor, comprising
mixing barium titanate-based main component powder and subcomponent powder to prepare a dielectric slurry;
manufacturing a plurality of dielectric green sheets from the dielectric slurry and forming a conductive paste layer on a surface of each dielectric green sheet among the plurality of dielectric green sheets;
manufacturing a dielectric green sheet stack by stacking the plurality of dielectric green sheets on which the conductive paste layer is formed;
manufacturing a capacitor body including a dielectric layer and an internal electrode layer by firing the dielectric green sheet stack; and
forming an external electrode on one surface of the capacitor body,
wherein the dielectric layer includes a barium titanate-based main component and a subcomponent including cerium (Ce) and dysprosium (Dy),
the subcomponent powder includes a Ce-containing compound and a Dy-containing compound, and the Ce-containing compound and the Dy-containing compound are included in an amount such that a Ce/Dy molar ratio is 1 to 10.

12. The method of claim 11, wherein
the Ce-containing compound is included in an amount such that Ce is 1 part by mole to 2 parts by mole based on 100 parts by mole of the barium titanate-based main component.

13. The method of claim 11, wherein
the Dy-containing compound is included in an amount such that Dy is 0.2 parts by mole to 1 part by mole based on 100 parts by mole of the barium titanate-based main component.

14. The method of claim 11, wherein
the Ce-containing compound and the Dy-containing compound each include an oxide, a nitride, or a salt compound, or
the Ce-containing compound and the Dy-containing compound each includes a sol form dispersed in an organic solvent.

15. The method of claim 11, wherein
the Ce-containing compound includes CeO₂, and
the Dy-containing compound includes Dy₂O₃.

16. A multilayer ceramic capacitor, comprising
a capacitor body including a dielectric layer and an internal electrode layer, the dielectric layer including cerium (Ce) and dysprosium (Dy), wherein a Ce/Dy molar ratio is 1 to 10, and
an external electrode disposed on an outer surface of the capacitor body.

17. The multilayer ceramic capacitor of claim 16, wherein
the dielectric layer includes a plurality of dielectric grains.

18. The multilayer ceramic capacitor of claim 17, wherein
the dielectric layer includes a first plurality of dielectric layers and a second plurality of dielectric layers,
the internal electrode layer includes a plurality of internal electrode layers,
the capacitor body includes:
an active region that includes the first plurality of the dielectric layers and the plurality of the internal electrode layers alternately arranged, and
a cover region that includes the second plurality of dielectric layers disposed on surfaces of the active region opposing each other in a thickness direction,
wherein the active region includes an active center defined as a region from an exact center of the active region to a region where two dielectric layers, among the first plurality of dielectric layers, along the thickness direction, and adjacent to the center of the active region, are visible under a microscope, and an active end defined as a region from a boundary between the active region and the cover region to a region where four dielectric layers among the first plurality of dielectric layers are visible under a microscope, and
when an average size of the plurality of dielectric grains at the active center is D1 and the average size of the plurality of dielectric grains at the active end is D2, a dielectric grain size deviation rate obtained from Equation 1 is greater than or equal to 0% and less than 10%:
$$Dielectric grain size deviation rate ( \% ) = ( \vert D 1 - D 2 \vert / D 1 ) \times 100 \qquad [ Equation 1 ]$$
wherein a size of the plurality of dielectric grains is an average value of a major axis length and a minor axis length of the plurality of dielectric grains.

19. The multilayer ceramic capacitor of claim 18, wherein
when the dielectric grain size deviation rate is greater than 0% and less than 10%, D1 has a value greater than D2.

20. The multilayer ceramic capacitor of claim 18, wherein
D1 is 210 nm to 230 nm.

21. The multilayer ceramic capacitor of claim 18, wherein
D2 is 200 nm to 220 nm.
